(19) United States
(12) Patent Application Publication
(10) Pub. No.: US 2009/0257458 A1
(43) Pub. Date: Oct. 15, 2009

(54) CLOCK SYNCHRONIZATION SYSTEM

(75) Inventors: Zhenlong Cui, Tokyo (JP); Masaki Umayabashi, Tokyo (JP); Kazuo Takagi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/420,532

(22) Filed: Apr. 8, 2009

(30) Foreign Application Priority Data
Apr. 9, 2008 (JP) 2008-101766

(51) Int. Cl. H04J 3/06

(52) U.S. Cl. 370/503

(57) ABSTRACT

A clock synchronization system includes a master node; a PSN (Packet Switched Network); and a slave node configured to synchronize a recovery clock signal in the slave node with a clock signal in the master node by using packets periodically received from the master node through the PSN. The slave node includes: a buffer section having a buffer and configured to temporarily store the packets received from the master node in the buffer, to monitor and output a buffer accumulation amount, and to output data of the packets from the buffer in response to the recovery clock signal; a maximum extracting section configured to receive the buffer accumulation amount from the buffer and to extract a maximum value for each time period from the buffer accumulation amount; a control section configured to generate a control voltage such that the maximum values from the maximum extracting section are held at a reference value; and a VCO (Voltage Controlled Oscillator) configured to adjust a frequency of the recovery clock signal based on the control voltage from the control section.

### INCORPORATION BY REFERENCE

This patent application claims priority on convention based on Japanese Patent Application No. 2008-101766. The disclosure thereof is incorporated herein by reference.

### TECHNICAL FIELD

The present invention relates to a clock synchronization system and a clock synchronization method, in which clock signals are synchronized between different apparatuses through a packet network. More particularly, the present invention relates to a clock synchronization system and a clock synchronization method, in which a clock offset between a master node and a slave node is corrected in a packet network.

### BACKGROUND ART

Communication service providers are promoting the construction of high-speed data communication networks, aiming at provision of services with a greater added value. The high-speed data communication network needs to have a large traffic capacity, and accordingly, the Internet Protocol (hereinafter, IP) system is more suitable because of its high efficiency and low cost, than the Time Division Multiplex (hereinafter, TDM) system which requires a higher cost.

In the TDM system, clock synchronization has been already accomplished. A terminal terminating a TDM signal is normally synchronized with a clock signal supplied from a network, and therefore a bit rate is coincident with each other between transmission and reception terminals.

On the other hand, in the Packet Switched Network (hereinafter, PSN) employing the IP system, the clock synchronization is not performed in the network, and the clock of the transmission terminal is self-running. Accordingly, in the PSN, it is difficult to utilize an application that requires highly accurate clock data. In a mobile network, an accurate clock is indispensable in order to smoothly perform a handover between cells. Specifically, clocks have to be synchronized between base stations in the mobile network in an accuracy of 50 parts per billion (hereinafter, ppb). If the clock of the base station drifts beyond this range, the handover between the cells may fail to be performed, which may result in packet loss and degradation in communication quality.

For this reason, a clock synchronization technique is required to establish accurate clock synchronization between the transmission and reception terminals. One of such clock synchronization techniques is known as an adaptive clock method disclosed in “B-ISDN ATM adaptation layer (AAL) specification: Type 1 AAL” (ITU-T Recommendation I.363.1, August, 1996) as a related art 1. The adaptive clock method will be described with reference to FIGS. 1A and 1B, as an example of the clock synchronization system.

As shown in FIG. 1A, the clock synchronization system includes a master node (transmission terminal) 1001, a slave node (reception terminal) 1002, and a PSN 1003. The master node 1001 periodically generates packets of a same size, and transmits the packets to the slave node 1002 through the PSN 1003.

As shown in FIG. 1B, the slave node 1002 includes a buffer 1021 and a clock recovering section 1022. In the slave node 1002, a packet transmitted by the master node 1001 is stored in the buffer 1021. The clock recovering section 1022 controls a read clock (recovery clock) f2 for the buffer 1021, so as to maintain a buffer accumulation amount at a reference value.

In the adaptive clock method, when the buffer accumulation amount of the slave node 1002 is at a reference value, it is regarded that the recovery clock signal f2 is synchronized with a clock signal f1 of the master node 1001 (in case of no influence of the PSN), and the recovery clock signal f2 is maintained in a preceding state. When the buffer accumulation amount is lower than the reference value, it is determined that the frequency of the clock signal f2 is higher than a clock signal frequency f1, and the clock frequency of the clock signal f2 is decreased. On the contrary, when the buffer accumulation amount is higher than the reference value, it is determined that a frequency of the clock signal f2 is lower than a frequency of the clock signal f1, and the clock signal frequency is increased.

However, a queuing delay Q (k) occurs in addition to a fixed delay D_{fix} in the PSN as shown in FIG. 2, and therefore packet propagation delay time fluctuates. Naturally, the fluctuation of the packet propagation delay time results in fluctuation of the buffer accumulation amount in the slave node 1002. Here, the queuing delay Q (k) is caused due to a fact that packets transmitted from the master node 1001 collides with another packet being transferred though the PSN 1003, and is randomly made to wait in a queue of a switch.

To realize highly accurate clock synchronization, the influence of the queuing delay in the PSN 1003 has to be excluded. Various studies have been made on this theme, and there are known techniques described in “Jitter and clock recovery for periodic traffic in broadband packet networks” (IEEE Trans. On Commun., vol. 42, pp. 2189-2196, May, 1994) by R. P. Singh, S. -H. Lee, and C. -K. Kim as a related art 2, and “Clock Synchronization Technique for Circuit Emulation” (Proceedings of the IEICE General Conference, 2004, B-8-7, p. 340) by FUKADA Youichi, and SAITO Koichi as a related art 3. In these techniques, the buffer accumulation amount in the slave node 1002 is averaged, to suppress influence of the randomly fluctuating queuing delay. A basic structure of the clock recovering section 1022 will be described below.

Referring to FIG. 3, the clock recovering section 1022 includes an averaging section 1221a, a control section 1222, and a Voltage Controlled Oscillator (hereinafter, VCO) 1223. The buffer 1021 once accumulates packets received from the PSN 1003, and outputs data at the frequency of the recovery clock signal f2. The buffer 1021 also monitors the buffer accumulation amount each time the packet is received, to calculate a difference from a reference value (for example, a half of the buffer capacity), and then outputs the difference to the averaging section 1221. The averaging section 1221 averages the differences received from the buffer 1021, and controls a voltage to be applied to the VCO 1223 according to the averaged value. The VCO 1223 varies the frequency of the clock signal f2 based on the control voltage received from the averaging section 1221a.

However, in a conventional clock synchronization system, an averaging process of the jitter buffer accumulation amount cannot minimize the influence of a queuing delay, and an offset remains in the recovery clock signal frequency deviation, as shown in FIG. 5. This is because in the method according to the above related arts 1 to 3, the difference between a monitored value of the buffer accumulation amount in a time Δt and the reference value is averaged, to reduce a fluctuation of the buffer accumulation amount due to the queuing delay, as shown in FIG. 4. However, since the queuing delay Q (k)≧0, an average value of the differences cannot be minimized even though the clock signal of the slave node 1002 and that of the master node 1001 are completely synchronized.

### SUMMARY

Accordingly, an object of the present invention is to provide a clock synchronization system and a clock synchronization method, in which the influence of a queuing delay Q (k) in a time period Δt on clock synchronization accuracy can be minimized.

In an aspect of the present invention, a clock synchronization system includes a master node; a PSN (Packet Switched Network); and a slave node configured to synchronize a recovery clock signal in the slave node with a clock signal in the master node by using packets periodically received from the master node through the PSN. The slave node includes: a buffer section having a buffer and configured to temporarily store the packets received from the master node in the buffer, to monitor and output a buffer accumulation amount, and to output data of the packets from the buffer in response to the recovery clock signal; a maximum extracting section configured to receive the buffer accumulation amount from the buffer and to extract a maximum value for each time period from the buffer accumulation amount; a control section configured to generate a control voltage such that the maximum values from the maximum extracting section are held at a reference value; and a VCO (Voltage Controlled Oscillator) configured to adjust a frequency of the recovery clock signal based on the control voltage from the control section.

In another aspect of the present invention, in a slave node, a clock signal in the slave node is synchronized with a clock signal in a master node by using packets periodically received from the master node through a PSN (Packet Switched Network). The slave node includes: a buffer section having a buffer and configured to temporarily store the packets received from the master node in the buffer, to monitor and output a buffer accumulation amount, and to output data of the packets from the buffer in response to the recovery clock signal; a maximum extracting section configured to receive the buffer accumulation amount from the buffer and to extract a maximum value for each time period from the buffer accumulation amount; a control section configured to generate a control voltage such that the maximum values from the maximum extracting section are held at a reference value; and a VCO (Voltage Controlled Oscillator) configured to adjust a frequency of the recovery clock signal based on the control voltage from the control section.

In still another aspect of the present invention, a clock synchronization method of synchronizing a clock signal in the slave node with a clock signal in a master node by using packets periodically received from the master node through a PSN (Packet Switched Network) is provided. The clock synchronization method is achieved by temporarily storing packets received from the master node in a buffer of a buffer section; by monitoring a buffer accumulation amount; by outputting data of the packets from the buffer in response to the recovery clock signal; by extracting a maximum value for each time period from the buffer accumulation amount; by generating a control voltage such that the maximum values are held at a reference value; and by adjusting a frequency of the recovery clock signal based on the control voltage.

In yet still another aspect of the present invention, a computer-readable recording medium is provided in which a computer-readable program code is recorded to realize a clock synchronization method of synchronizing a clock signal in the slave node with a clock signal in a master node by using packets periodically received from the master node through a PSN (Packet Switched Network). The clock synchronization method is achieved by temporarily storing packets received from the master node in a buffer of a buffer section; by monitoring a buffer accumulation amount; by outputting data of the packets from said buffer in response to the recovery clock signal; by extracting a maximum value for each time period from he buffer accumulation amount; by generating a control voltage such that the maximum values are held at a reference value; and by adjusting a frequency of the recovery clock signal based on the control voltage.

According to the present invention, the clock synchronization system monitors a maximum value of a buffer accumulation amount for each time period in a slave node, and controls a recovery clock signal frequency in the slave node such that the maximum value of the buffer accumulation amount is held at a reference value of the buffer accumulation amount. Thus, the influence of the queuing delay in a PSN can be minimized.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1A is a block diagram showing a configuration of a conventional clock synchronization system;

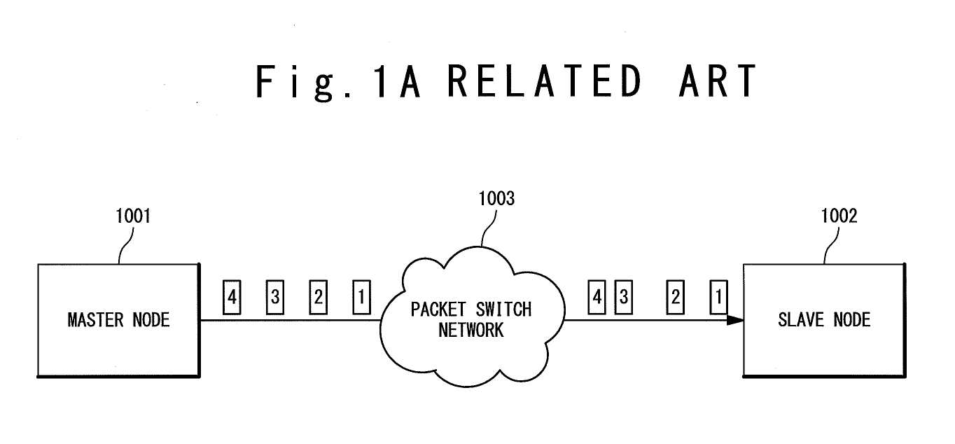

FIG. 1B is a block diagram showing a configuration of a slave node in the conventional clock synchronization system;

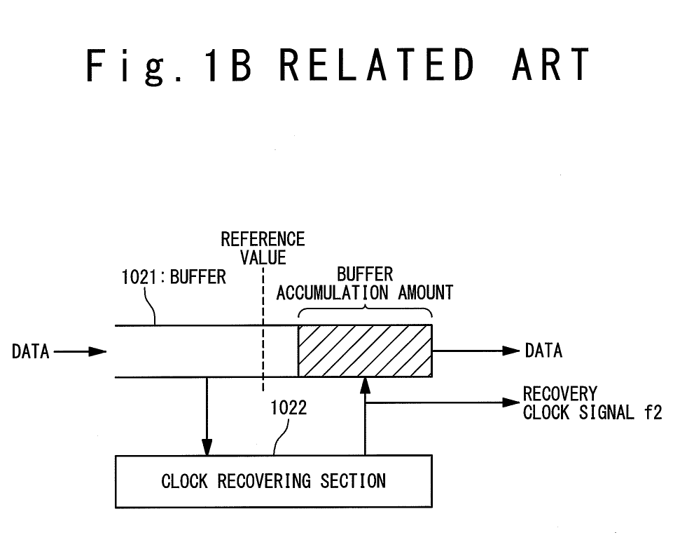

FIG. 2 is a diagram showing a propagation delay of a packet sequence transmitted from a master node;

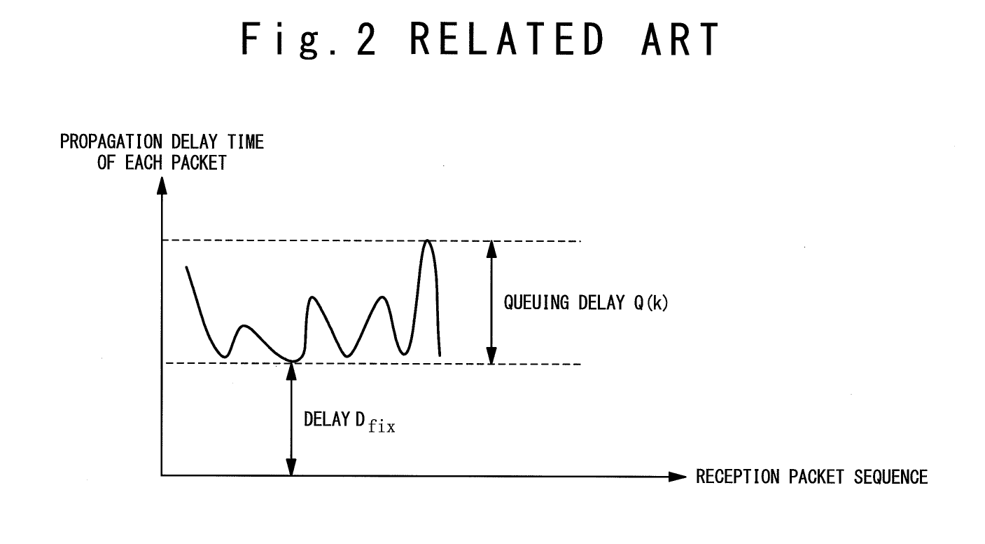

FIG. 3 is a block diagram showing a configuration of a clock recovering section in the conventional clock synchronization system;

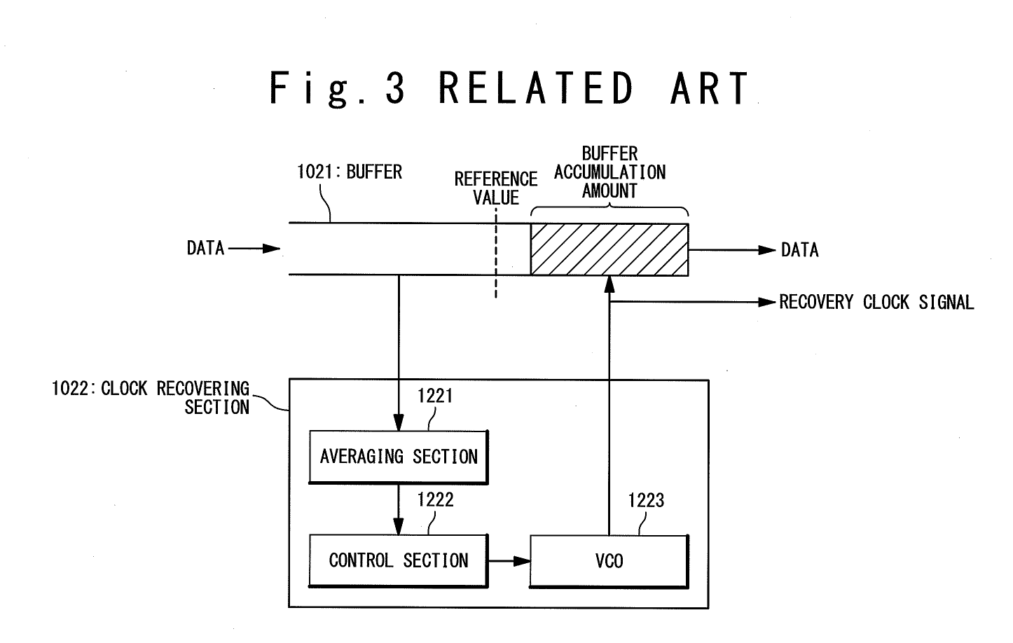

FIG. 4 is a diagram showing an averaging result of a buffer accumulation amounts in the conventional clock synchronization system;

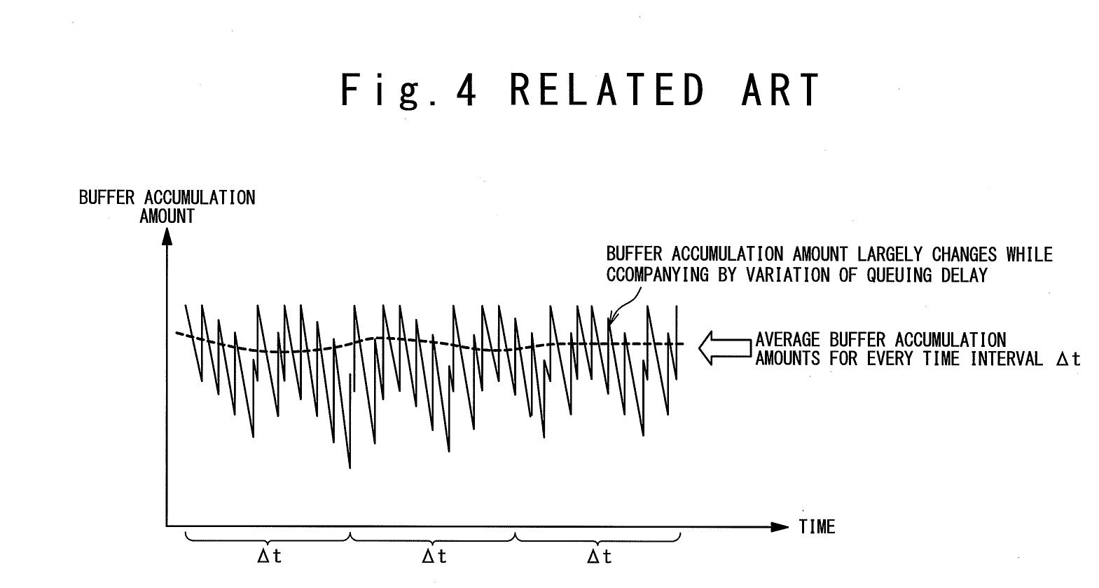

FIG. 5 is a diagram showing a clock signal frequency fluctuation in the conventional clock synchronization system;

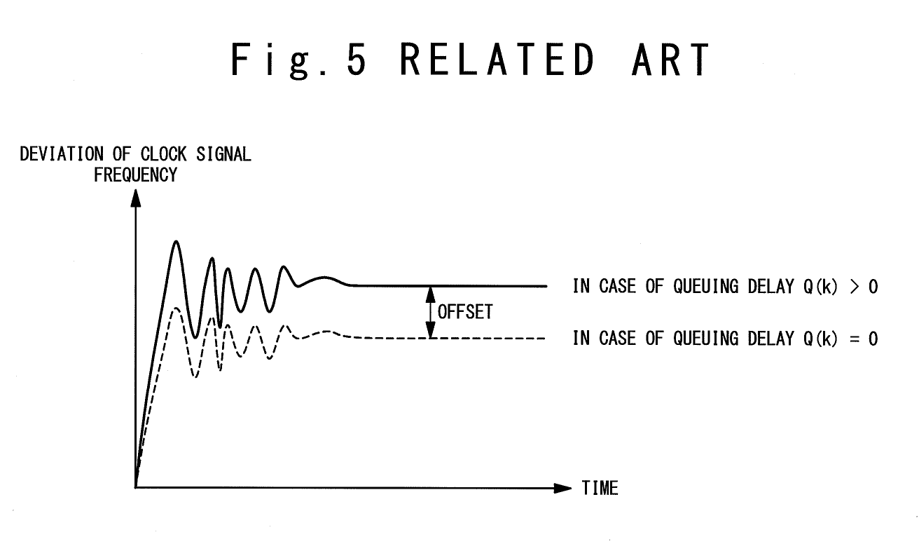

FIG. 6A is a block diagram showing a configuration of a clock synchronization system according to the present invention;

FIG. 6B is a block diagram showing a configuration of a slave node in the clock synchronization system according to a first exemplary embodiment;

FIG. 7 is a diagram showing a buffer accumulation amount when a clock signal is completely synchronized and a queuing delay is zero, in the clock synchronization system according to the first exemplary embodiment;

FIG. 8 is a diagram showing the buffer accumulation amount when the clock signal is completely synchronized but the queuing delay is not zero, in the clock synchronization system according to the first exemplary embodiment;

FIG. 9 is a diagram showing the buffer accumulation amount when the clock signal is not synchronized and the queuing delay is not zero, in the clock synchronization system according to the first exemplary embodiment;

FIG. 10 is a block diagram showing a configuration of the slave node in the clock synchronization system according to a second exemplary embodiment of the present invention; and

FIG. 11 is a block diagram showing a configuration of the slave node in the clock synchronization system according to a third exemplary embodiment of the present invention.

### EXEMPLARY EMBODIMENTS

Hereinafter, a clock synchronization system according to the present invention will be described in details with reference to the attached drawings.

### First Exemplary Embodiment

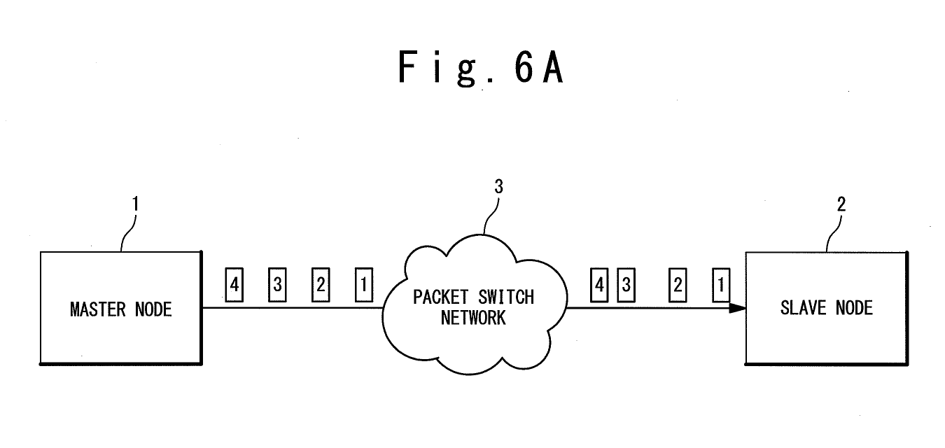

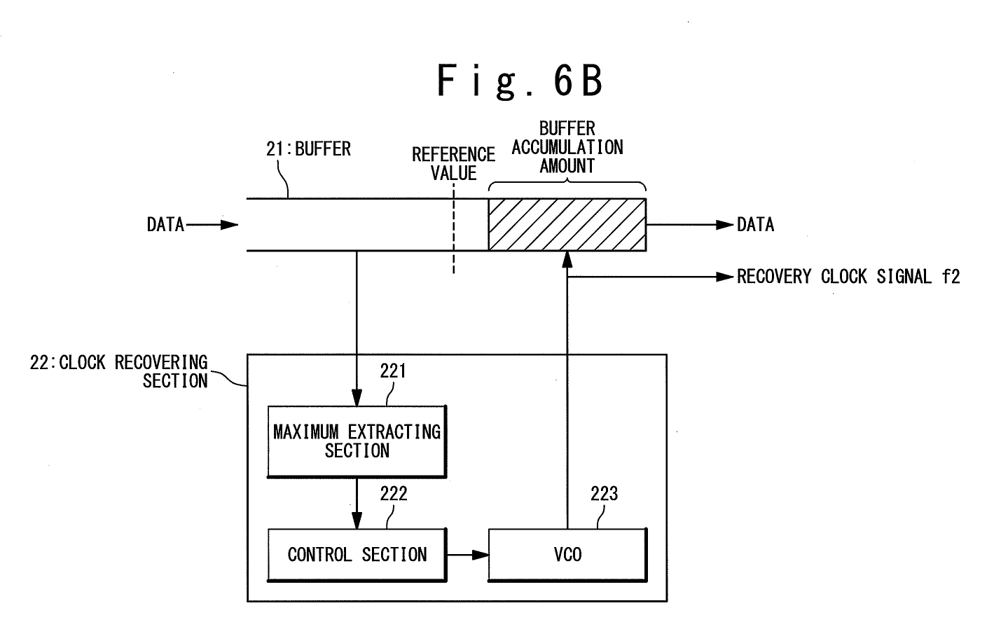

Referring to FIG. 6A, the clock synchronization system according to a first exemplary embodiment of the present invention includes a master node (transmission terminal) 1 which is a computer, a slave node (reception terminal) 2 which is another computer, and a Packet Switched Network (PSN) 3. The functions of the slave node 2 to be described below may be attained by hardware or software. In case of the software, the functions are attained by a CPU executing a program which is loaded from a recording medium (not shown). The master node 1 periodically generates packets of a same size, and transmits the packets to the slave node 2 through the PSN 3. As shown in FIG. 6B, the slave node 2 includes a buffer 21 of a buffer section, and a clock recovering section 22.

The buffer 21 may be an actual buffer or a buffer counter. When the buffer 21 is the actual buffer, the packets transmitted from the master node 1 need to have a fixed size. The actual buffer temporarily stores the packets received from the master node 1, and outputs data at the frequency of a recovery clock signal f2. The buffer section monitors a buffer accumulation amount each time the packet is received, and outputs the buffer accumulation amount to the clock recovering section 22.

When the buffer 21 is the buffer counter, the packets transmitted from the master node 1 may be of a fixed size or of a variable size. When the packets transmitted from the master node 1 is of the fixed size, the buffer accumulation amount is equal to “packet size value×the number of packets received”, and the buffer 21 outputs the buffer accumulation amount to the clock recovering section 22. When the packets transmitted from the master node 1 is of the variable size, the buffer accumulation amount is equal to “a fixed value×the number of packets received”, and the buffer 21 outputs the buffer accumulation amount to the clock recovering section 22. The fixed value is set to a certain value independent from the size of the received packet. The buffer counter not only counts up the buffer accumulation amount, but also counts down the buffer accumulation amount while the data is outputted at the frequency of the recovery clock signal f2.

As shown in FIG. 6B, the clock recovering section 22 includes a maximum extracting section 221, a control section 222, and a VCO (Voltage Controlled Oscillator) 223. The maximum extracting section 221 receives the buffer accumulation amount from the buffer 21, and selects a maximum value MAX_BUF(K) of the buffer accumulation amount for each time period Δt, and outputs the maximum value to the control section 222. The control section 222 compares the maximum value MAX_BUF(K) of the buffer accumulation amount received from the maximum extracting section 221 and a reference value, to calculate a difference ΔMAX_BUF(K). The control section 222 also outputs a control voltage to the VCO 223 based on the difference ΔMAX_BUF (K). The VCO 223 varies the frequency of the recovery clock signal f2 based on the control voltage received from the control section 222.

Next, in the above configuration, the master node 1 transmits the packets to the slave node 2 through the PSN 3 in a constant interval. The slave node 2 stores the received packets in the buffer 21, and controls a read clock signal such that the buffer accumulation amount is maintained at the reference value.

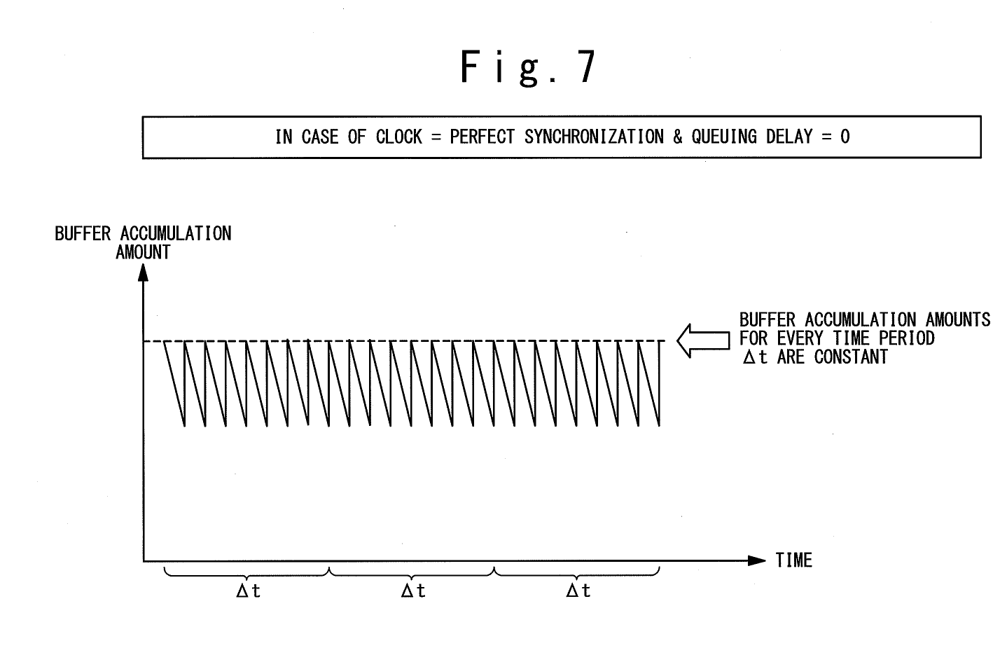

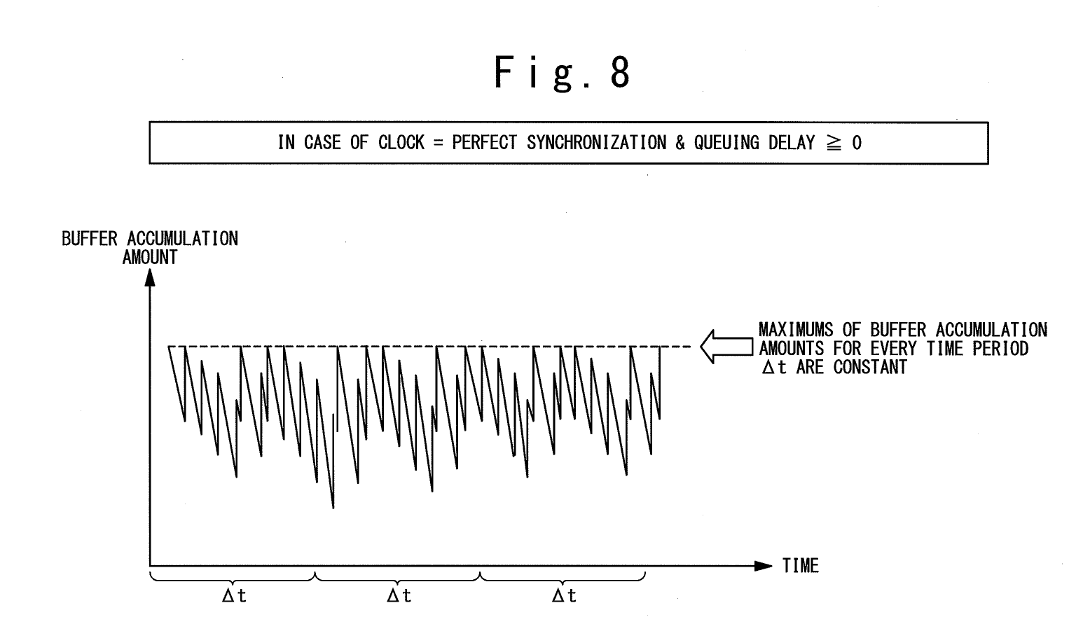

In case that the clock signal in the master node 1 and that in the slave node 2 are completely synchronized with each other and a queuing delay in the PSN 3 is zero, the MAX_BUF(K) of the buffer accumulation amount for each time period Δt becomes constant, as shown in FIG. 7. However, since the queuing delay randomly occurs in the PSN 3, the buffer accumulation amount in the slave node 2 also fluctuates randomly. When the clock signal in the master node 1 and that in the slave node 2 are completely synchronized with each other, the buffer accumulation amount upon receipt of a packet having a queuing delay is reduced, compared with a case that the queuing delay is zero. In other words, when the packet having a minimum queuing delay is received, the buffer accumulation amount in the slave node 2 becomes largest, as shown in FIG. 8. FIG. 8 represents a case that the clock signal in the master node 1 and that in the slave node 2 are completely synchronized with each other.

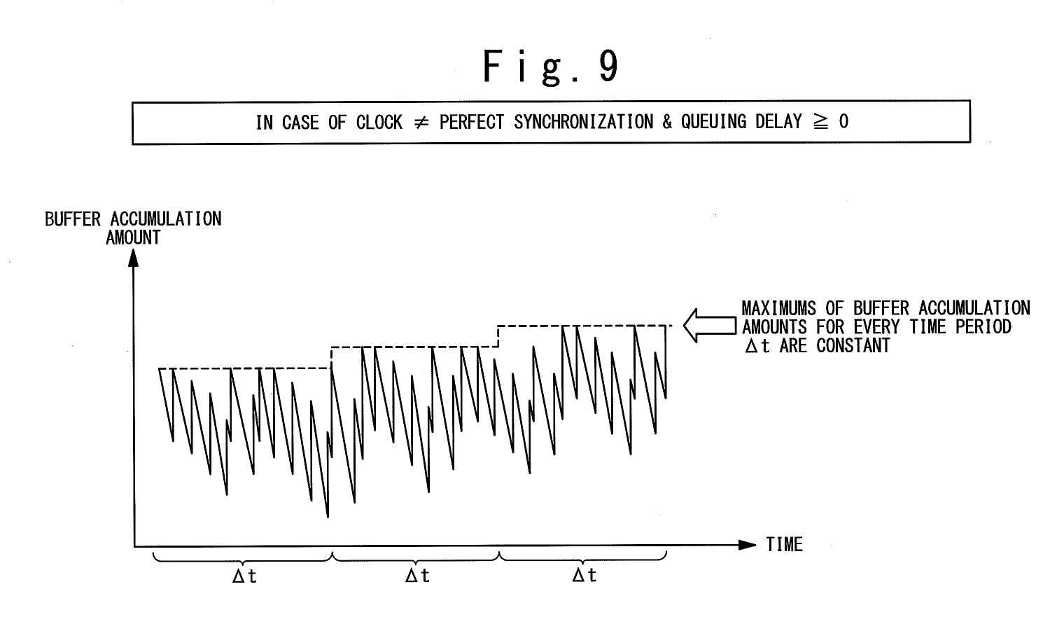

When the clock signal in the master node 1 and that of the slave node 2 are not completely synchronized with each other, the maximum value MAX_BUF(K) of the buffer accumulation amount fluctuates due to a clock signal drift in the slave node 2, as shown in FIG. 9.

In the present exemplary embodiment, only the maximum value of the buffer accumulation amount for each time period Δt is adopted to minimize the influence of the queuing delay, thus achieving highly accurate clock synchronization.

Referring to FIGS. 6A and 6B, an operation according to the present exemplary embodiment will now be described in detail. The slave node 2 receives the packets transmitted from the master node 1, and stores the packets in the buffer 21. The buffer 21 monitors the buffer accumulation amount, and notifies it to the maximum extracting section 221 of the clock recovering section 22, as shown in FIG. 6B. The maximum extracting section 221 monitors the maximum value MAX_BUF (K) for each time period Δt from the buffer accumulation amount received from the buffer 21, and notifies the maximum value MAX_BUF (K) to the control section 222.

The control section 222 compares the MAX_BUF (K) received from the maximum extracting section 221 with the reference value of the buffer accumulation amount, and generates a control voltage to be applied to the VCO 223 based on the difference. The VCC 24 varies the frequency of the recovery clock signal f2(k) based on the control voltage received from the control section 23.

According to the first exemplary embodiment of the present invention, the clock synchronization system monitors the maximum value MAX_BUF(k) of the buffer accumulation amount for each time period Δt in the slave node 2, and the frequency of the recovery clock signal f2 in the slave node 2 is controlled such that the MAX_BUF(K) is maintained at the reference value for the buffer accumulation amount. Thus, it is possible to minimize the influence of the queuing delay in the PSN 3.

### Second Exemplary Embodiment

When a packet loss has not to be taken into consideration, degradation in clock synchronization accuracy occurs. For this reason, in the clock synchronization system according to a second exemplary embodiment of the present invention, it is desired to prevent the degradation in a clock accuracy originating from the packet loss. In the second exemplary embodiment, the description given in the first exemplary embodiment will not be repeated.

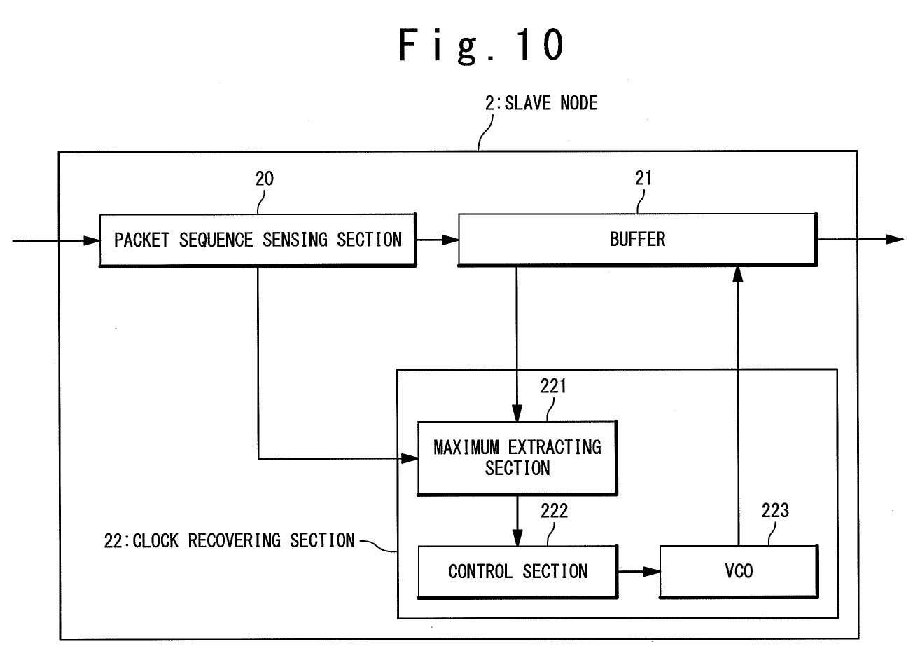

Referring to FIG. 10, the slave node 2 of the clock synchronization system according to the second exemplary embodiment includes the buffer 21, the clock recovering section 22, and a packet sequence detecting section 20. In other words, the slave node 2 includes the packet sequence detecting section 20, in addition to the configuration of the slave node 2 of the first exemplary embodiment shown in FIG. 6B. The packet sequence detecting section 20 detects a packet loss state based on sequence numbers of the packets transmitted from the master node 1. The packet sequence detecting section 20 detects the sequence number of the packet, and determines whether or not the packet has been lost, when a packet is not received at a time where the packet is supposed to be received. Also, when the sequence of the packet is turned over and the packet is received at a subsequent position, the packet is not stored in the buffer 21. As a result, upon detecting the packet loss, the packet sequence detecting section 20 executes either of the following process 1 or 2.

Process 1: a dummy data of a same size as the lost packet is inserted at a position in the buffer 21 where the packet is supposed to be stored. When the packet transmitted from the master node 1 is a variable size, the dummy data of a predetermined fixed size is supplied.

Process 2: the detection of the packet loss is notified to the maximum extracting section 221, instead of storing the dummy data in the buffer 21.

The maximum extracting section 221 monitors the buffer accumulation amount for each time period Δt and extracts the maximum value MAX_BUF(k). The maximum extracting section 221 further adds a value corresponding to the size of the lost packet of the fixed size to the maximum value MAX_BUF(k) of the buffer accumulation amount upon receipt of a notice from the packet sequence detecting section 20 (to indicate that the packet loss has been detected). When the packet transmitted from the master node 1 is of a variable size, a predetermined fixed value is added to the maximum value MAX_BUF(k) of the buffer accumulation amount.

The buffer 21, the control section 222, and the VCO 223 shown in FIG. 10 operate in the same way as those of the first exemplary embodiment, and accordingly the description will be omitted.

The packet loss cannot be detected in the first exemplary embodiment. Since the buffer accumulation amount is reduced when the packet loss occurs, the clock synchronization accuracy may be degraded without a function of the packet loss detection (packet sequence detecting section 20). For example, in the first exemplary embodiment, it is assumed that the buffer accumulation amount becomes highest when a packet free from the queuing delay is received. However, when the packet loss occurs, the buffer accumulation amount does not reach the maximum.

In the present exemplary embodiment, when detecting the packet loss, the packet sequence detecting section 20 supplies the dummy data of the same size as that of the lost packet (or of a predetermined fixed size) to the buffer 21, or notifies the detection of the packet loss to the maximum extracting section 221 of the clock recovering section 22.

The maximum extracting section 221 monitors the buffer accumulation amount, and extracts the maximum value MAX_BUF(K) of the buffer accumulation amount for each time period, as in the first exemplary embodiment. In the present exemplary embodiment, the maximum extracting section 221 adds a same value as the size of the lost packet (or a predetermined fixed value) to the maximum value MAX_BUF(k) of the buffer accumulation amount, upon receipt of the notice of the detection of packet loss from the packet sequence detecting section 20.

The clock synchronization system according to the second exemplary embodiment of the present invention has a function of detecting the packet sequence (packet sequence detecting section 20) to supply the dummy data of the same size as that of a lost packet (or of a predetermined fixed size), or notify the detection of the packet loss to the maximum extracting section 221 of the clock recovering section 22. Thus, the influence of the queuing delay in the PSN can be minimized, as well as preventing the degradation of clock synchronization accuracy resulting from the packet loss.

### Third Exemplary Embodiment

As self-running time of the recovery clock becomes longer, the influence of a temperature drift on the clock drift in the slave node 2 becomes greater, which results in degradation of a clock signal accuracy. While it is desirable to extend the time period Δt for the maximum value of the buffer accumulation amount, in order to minimize the influence of the queuing delay, extension of the time period Δt makes the VCO in the slave node 1002 more susceptible to the temperature drift. In a third exemplary embodiment of the present invention, the description given in the first and the second exemplary embodiment will be omitted.

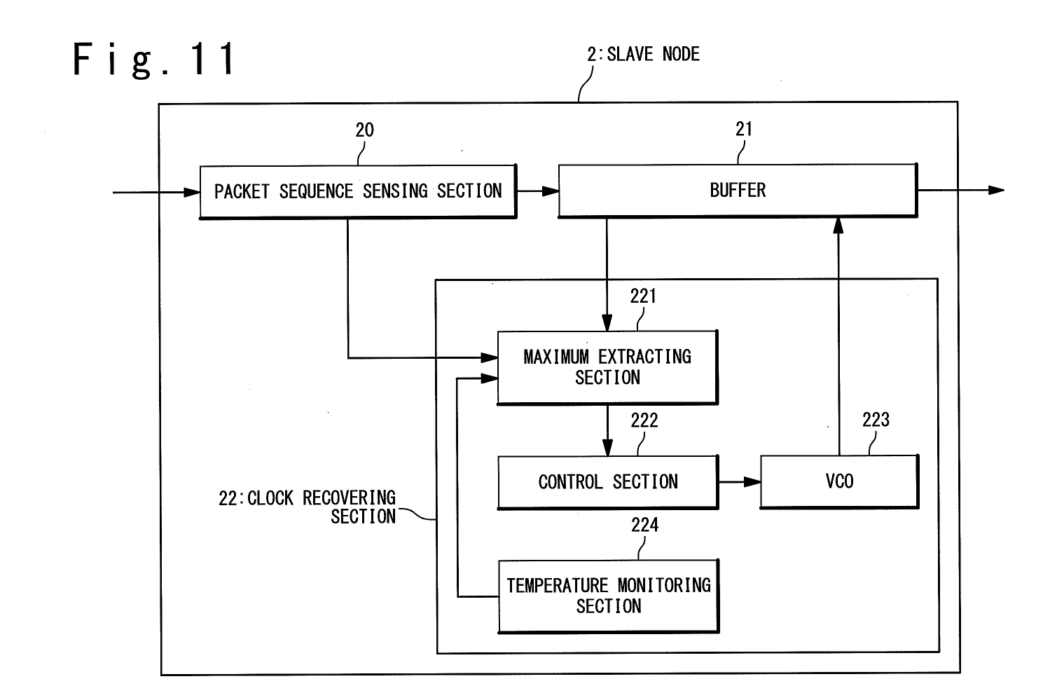

Referring to FIG. 11, the slave node 2 of the clock synchronization system according to the third exemplary embodiment includes the buffer 21, the clock recovering section 22, and the packet sequence detecting section 20. The clock recovering section 22 includes the maximum extracting section 221, the control section 222, the VCO 223, and a temperature monitoring section 224. In other words, clock recovering section 22 of the slave node 2 includes the temperature monitoring section 224, in addition to the configuration of the slave node 2 of the second exemplary embodiment shown in FIG. 10.

The temperature monitoring section 224 measures an internal temperature of the slave node, and notifies a change amount of the internal temperature to the maximum extracting section 221.

The maximum extracting section 221 monitors the buffer accumulation amount and extracts the maximum value MAX_BUF(k) of the buffer accumulation amount for each time period Δt. The maximum extracting section 221 also adjusts the time period Δt upon receipt of the temperature change amount from the temperature monitoring section 224 such that the influence of the temperature drift and the influence of the queuing delay on the clock synchronization accuracy are optimally balanced. For example, when the temperature change is relatively large, the slave node 2 is controlled such that the self-running time of the recovery clock signal is shortened as much as possible.

The packet sequence detecting section 20, the buffer 21, the control section 221, and the VCO 223 shown in FIG. 11 operate in the same way as those of the second exemplary embodiment, and accordingly, the same description will be omitted.

In the conventional clock synchronization system, primary factors in the adaptive clock method that affect the clock synchronization accuracy are a queuing delay in the PSN and a clock drift in the slave node. In the first and second exemplary embodiments, the influence of the former is minimized, but the influence of the latter is not.

The clock drift in the slave node predominantly depends on the internal temperature of the slave node. For example, on an assumption that the VCO 223 changes by 20 ppm due to a temperature change from −40 to +80° C., the frequency of the recovery clock signal f2 changes by 0.17 ppm/° C., from a simple averaging of 20 ppm/120° C. In this case, if the internal temperature of the slave node changes by 1° C. during the time period Δt, the self-running clock signal frequency changes by 0.17 ppm during the time period Δt, which does not meet the required accuracy of 50 ppb.

To accomplish the required accuracy of 50 ppb, it is necessary to shorten the self-running time period Δt to suppress the influence of the temperature drift. On the other hand, excessively shortening the self-running time period Δt makes influence of the queuing delay in the PSN 3 greater.

In the present exemplary embodiment, the following process is executed in order to suppress the influence of the temperature drift.

The temperature monitoring section 224 measures the internal temperature of the slave node, and supplies the change amount of the internal temperature to the maximum extracting section 221. When receiving the temperature change amount from the temperature monitoring section 224, the maximum extracting section 221 takes into consideration, not only the queuing delay in the PSN 3 but also the degradation in clock accuracy based on the characteristic of the VCO, and controls the self-running time period Δt so as to achieve an optimal balance between the influence of the queuing delay and that of the temperature drift on the clock synchronization accuracy.

The clock synchronization system according to the third exemplary embodiment of the present invention has a function of monitoring temperature (temperature monitoring section 224), to determine the time period Δt for adjusting the frequency of the recovery clock signal f2 in consideration of the temperature drift. The influence of the queuing delay and the temperature drift on the clock synchronization accuracy is controlled to an optimal balance, thereby upgrading the clock accuracy.

While the present invention has been particularly shown and described with reference to the exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. A clock synchronization system comprising:
a master node;
a PSN (Packet Switched Network); and
a slave node configured to synchronize a recovery clock signal in said slave node with a clock signal in said master node by using packets periodically received from said master node through said PSN,
wherein said slave node comprises:
a buffer section having a buffer and configured to temporarily store the packets received from said master node in said buffer, to monitor and output a buffer accumulation amount, and to output data of the packets from said buffer in response to the recovery clock signal;
a maximum extracting section configured to receive the buffer accumulation amount from said buffer and to extract a maximum value for each time period from the buffer accumulation amount;
a control section configured to generate a control voltage such that the maximum values from said maximum extracting section are held at a reference value; and
a VCO (Voltage Controlled Oscillator) configured to adjust a frequency of the recovery clock signal based on the control voltage from said control section.

2. The clock synchronous system according to claim 1, wherein said slave node further comprises:
a packet sequence detecting section configured to detect a packet loss based on sequence numbers of the received packets, and to store in said buffer, a dummy data of a same size as a lost packet in case of the packet having a fixed size and a dummy data of a predetermined fixed size in case of the packet of a predetermined fixed size, when detecting the packet loss.

3. The clock synchronous system according to claim 1, wherein said slave node further comprises:
a packet sequence detecting section configured to detect a packet loss based on sequence numbers of the received packets, and to notify the detection of the packet loss to said maximum extracting section, when detecting the packet loss,
wherein said maximum extracting section further adds a value corresponding to the lost packet in case of the packet of a fixed size or a predetermined fixed value in case of the packet of a variable size, to the maximum value for every time period in response to a notice of the detection of the packet loss from said packet sequence detecting section.

4. The clock synchronous system according to claim 1, wherein said slave node further comprises:
a temperature monitoring section configured to monitor an internal temperature of said slave node and to notify a change amount of the internal temperature to said maximum extracting section,
said maximum extracting section adjusts the time period in said slave node based on the change amount of the internal temperature from said temperature monitoring section.

5. A slave node in which a clock signal in said slave node is synchronized with a clock signal in a master node by using packets periodically received from said master node through a PSN (Packet Switched Network), said slave node comprising:
a buffer section having a buffer and configured to temporarily store the packets received from said master node in said buffer, to monitor and output a buffer accumulation amount, and to output data of the packets from said buffer in response to the recovery clock signal;
a maximum extracting section configured to receive the buffer accumulation amount from said buffer and to extract a maximum value for each time period from the buffer accumulation amount;
a control section configured to generate a control voltage such that the maximum values from said maximum extracting section are held at a reference value; and
a VCO (Voltage Controlled Oscillator) configured to adjust a frequency of the recovery clock signal based on the control voltage from said control section.

6. The slave node according to claim 5, further comprising:
a packet sequence detecting section configured to detect a packet loss based on sequence numbers of the received packets, and to store in said buffer, a dummy data of a same size as a lost packet in case of the packet having a fixed size and a dummy data of a predetermined fixed size in case of the packet of a predetermined fixed size, when detecting the packet loss.

7. The slave node according to claim 5, further comprising:
a packet sequence detecting section configured to detect a packet loss based on sequence numbers of the received packets, and to notify the detection of the packet loss to said maximum extracting section, when detecting the packet loss,
wherein said maximum extracting section further adds a value corresponding to the lost packet in case of the packet of a fixed size or a predetermined fixed value in case of the packet of a variable size, to the maximum value for every time period in response to a notice of the detection of the packet loss from said packet sequence detecting section.

8. The slave node according to claim 5, further comprising:
a temperature monitoring section configured to monitor an internal temperature of said slave node and to notify a change amount of the internal temperature to said maximum extracting section,
wherein said maximum extracting section adjusts the time period in said slave node based on the change amount of the internal temperature from said temperature monitoring section.

9. A clock synchronization method of synchronizing a clock signal in said slave node with a clock signal in a master node by using packets periodically received from said master node through a PSN (Packet Switched Network), said clock synchronization method comprising:
temporarily storing packets received from said master node in a buffer of a buffer section;
monitoring a buffer accumulation amount;
outputting data of the packets from said buffer in response to the recovery clock signal;
extracting a maximum value for each time period from the buffer accumulation amount;
generating a control voltage such that the maximum values are held at a reference value; and
adjusting a frequency of the recovery clock signal based on the control voltage.

10. The clock synchronization method according to claim 9, further comprising:
detecting a packet loss based on sequence numbers of the received packets;
storing in said buffer, a dummy data of a same size as a lost packet in case of the packet having a fixed size and a dummy data of a predetermined fixed size in case of the packet of a predetermined fixed size, when detecting the packet loss.

11. The clock synchronization method according to claim 9, further comprising:
detecting a packet loss based on sequence numbers of the received packets; and
notifying the detection of the packet loss, when detecting the packet loss; and
adding a value corresponding to the lost packet in case of the packet of a fixed size or a predetermined fixed value in case of the packet of a variable size, to the maximum value for every time period in response to a notice of the detection of the packet loss.

12. The clock synchronization method according to claim 9, further comprising:
monitoring an internal temperature of said slave node;
notifying a change amount of the internal temperature of said slave node; and
adjusting the time period in said slave node based on the change amount of the internal temperature.

13. A computer-readable recording medium in which a computer-readable program code is recorded to realize a clock synchronization method of synchronizing a clock signal in said slave node with a clock signal in a master node by using packets periodically received from said master node through a PSN (Packet Switched Network), wherein said clock synchronization method comprises:
temporarily storing packets received from said master node in a buffer of a buffer section;
monitoring a buffer accumulation amount;
outputting data of the packets from said buffer in response to the recovery clock signal;
extracting a maximum value for each time period from the buffer accumulation amount;
generating a control voltage such that the maximum values are held at a reference value; and
adjusting a frequency of the recovery clock signal based on the control voltage.

14. The computer-readable recording medium according to claim 13, wherein said clock synchronization method further comprises:
detecting a packet loss based on sequence numbers of the received packets;
storing in said buffer, a dummy data of a same size as a lost packet in case of the packet having a fixed size and a dummy data of a predetermined fixed size in case of the packet of a predetermined fixed size, when detecting the packet loss.

15. The computer-readable recording medium according to claim 13, wherein said clock synchronization method further comprises:
detecting a packet loss based on sequence numbers of the received packets; and
notifying the detection of the packet loss, when detecting the packet loss; and
adding a value corresponding to the lost packet in case of the packet of a fixed size or a predetermined fixed value in case of the packet of a variable size, to the maximum value for every time period in response to a notice of the detection of the packet loss.

16. The computer-readable recording medium according to claim 13, wherein said clock synchronization method further comprises:
monitoring an internal temperature of said slave node;
notifying a change amount of the internal temperature of said slave node; and
adjusting the time period in said slave node based on the change amount of the internal temperature.
